(19) United States
(12) Patent Application Publication
(10) Pub. No.: US 2011/0021153 A1
(43) Pub. Date: Jan. 27, 2011

(54) CENTRALIZED CROSS-LAYER ENHANCED METHOD AND APPARATUS FOR INTERFERENCE MITIGATION IN A WIRELESS NETWORK

(76) Inventor: Saeid Safavi, San Diego, CA (US)

Correspondence Address: Robert F. Gazdzinski, Esq.;Gazdzinski & Associates, Suite 201, 16644 West Bernardo Drive, San Diego, CA, 92127, US

(21) Appl. No.: 12/833,658

(22) Filed: Jul. 9, 2010

Related U.S. Application Data
(60) Provisional application No. 61/224,830, filed on Jul. 10, 2009.

(51) Int. Cl. H04B 15/00

(52) U.S. Cl. 455/63.1

(57) ABSTRACT

Apparatus and methods for improving the throughput and capacity of a wireless communications network. In one embodiment, this improvement is accomplished by focusing upon reduction of the co-channel interference, including the interferences that are unpredictable or undetectable to a traditional network. Various implementations detect the receiver interference (i.e. the interference affecting the receiver performance) at the transmitting node in order to avoid or reduce its effect at the receiving node. This detection can be as simple as e.g., spectral sensing constituting power measurement, and/or can be more sophisticated such as measurements including bandwidth, duty cycle and statistical behavior of the unwanted signal.

### PRIORITY

This application claims priority to U.S. Provisional Patent Application Ser. No. 61/224,830 entitled “CENTRALIZED CROSS-LAYER ENHANCED METHOD AND APPARATUS FOR INTERFERENCE MITIGATION IN A WIRELESS NETWORK” filed Jul. 10, 2009, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. TECHNICAL FIELD

This disclosure relates to interference mitigation in wireless communications networks, and at least some of the examples disclosed relate to cross-layer methodologies for performance enhancement of wireless networks

### 2. DESCRIPTION OF THE RELATED ART

Over the past decade, the wireless communications network technology has undergone tremendous evolution from voice communications-based cellular systems of the digital 2G cellular systems (e.g. GSM) to multi-service heterogeneous networks that can handle data and high speed multimedia in addition to voice applications (e.g. 3G cellular and beyond including WCDMA , HSPA, etc.), WiMAX, Wireless Local Area Networks (WLAN) and the future Long Term Evolution (LTE) or 4G cellular. These technologies were initially designed to serve a variety of wireless applications and coverage classes, ranging from WBAN (Wireless Body Area Networks) and WPAN (Wireless Personal Area Networks, e.g. Bluetooth), to WLAN (e.g. WiFi), WMAN (Wireless Metropolitan Area Networks such as WiMAX), all the way to WWAN (wireless wide area networks such as WCDMA and LTE).

As these new technologies evolve, the need for integration of various applications and services become increasingly necessary. For example today's WLAN is progressively integrated with the cellular third generation (3G) mobile communication system to improve the coverage and capacity. It is anticipated that in the near future a superposition of access networks of various architectures and topologies ranging from Pico-cellular systems (such as WPANS) to large cell sized or macro-cellular systems (such as WCDMA) covering a wide range of user applications and services. As the wireless networks evolve to support heterogeneous architectures with ubiquitous coverage, a high degree of adaptively and flexibility is required particularly in the radio access node (e.g. Access Point or Base Station).

In addition to the integration paradigm, due to the growing number of different wireless technologies and potential users on the one hand, and the scarcity of spectrum on the other hand, it is anticipated that in the absence of some form of interference management, the interference level (including co-channel interference, adjacent channel interference, etc.) can potentially grow with the scale of future network deployments. Co-channel interference in particular is of utmost importance as it can set limits to the performance and spectral efficiencies of wireless networks. This form of interference can be generated by other users of the same networks (termed self interference), adjacent uncoordinated networks, or other wireless devices sharing the spectrum (e.g. in unlicensed bands). Control of co-channel interference is also very important to the carriers and service providers as it determines the size and number of base access points (or base stations) in cellular network deployment, which in turn affects the overall network deployment costs.

Another byproduct of the evolving heterogeneous, multiplatform wireless networks is the unavoidable increase in the transmission environment hostility resulting in more random and time variable radio communications channels.

This radio channel agility and interference susceptibility along with the scarcity of wireless spectrum, motivated a large body of work to optimize the performance of wireless networks. This effort, highly focused on optimization of physical (PHY) layer, resulted in a number of innovative and effective methods for performance improvement of wireless networks. In parallel, advancement in IC design and integration technologies, resulted in the possibly of employment of complicated receiver algorithms that were initiated by the pioneering works in the 60's and the 70's, but were not feasible to implement in the near past.

Among the above advancements in the PHY-based radio link techniques, various types of advanced channel coding schemes such as turbo-codes, low-density parity-check codes (LDPC) and turbo product codes (TPC) have significantly improved the BER performance of wireless communications for a given level of signal-to-noise ratios (SNRs), resulting in improve spectral efficiencies. The combination of OFDM (orthogonal frequency division multiplexing) and MIMO (multiple input multiple output)-based multiple antenna systems is yet another important example of highly robust and attractive PHY-based solutions for broadband radio networks. The time variable nature of mobile wireless networks is effectively addressed by a PHY technique called adaptive modulation and coding (AMC) which dynamically allocate the modulation and coding resources to users, based on their channel condition (or channel state). The interference problem is addressed by a number of MIMO based signal processing algorithms applicable to both uplink and downlink, in addition to the classic interference cancellation methods.

In parallel to the information theory-based contributions applied to PHY-based resource allocation, MAC-based resource allocation strategies has also been optimized using a handful of advanced networking techniques [see Ref. 1].

A majority of communication systems can be modeled based on the so-called Open System Interconnection (OSI) structure in which different functionalities of the system are assigned to different layers. In this architecture each layer in the network is independently designed and optimized. However, the widely variable nature of future wireless networks and managing the scarcity of resources, demands optimization of not only the PHY layer, but also the other layers in the protocol stack. Some recent research [see Refs. 2,3,4] have shown that due to the strong relation among different protocol stack layers in wireless communications the OSI paradigm should be reconsidered by common optimization of the layers, i.e. a Cross-Layer approach. Similarly in another body of work throughput maximization and other QoS requirement optimization are used as performance metrics (instead of traditional performance metrics such as BER requirement) based on PHY/MAC strategies such as link adaptation and resource allocation strategies [see Refs. 5,6,7]. These researches and other works have shown that, the joint optimization of PHY-layer power allocation, MAC-layer scheduling of the radio links and the flow-assignment in Network-layer can significantly improve the performance.

### SUMMARY OF THE INVENTION

Embodiments of the invention are directed towards, inter alia, apparatus and methods for improving the throughput and capacity of a wireless communications network by focusing upon reduction of the co-channel interference, including the interferences that are unpredictable or undetectable to a standard network. Various embodiments detect the receiver interference (i.e. the interference affecting the receiver performance) at the transmitting node in order to avoid or reduce its effect at the receiving node. This detection can be as simple as spectral sensing constituting power measurement and/or can be more sophisticated such as measurements including bandwidth, duty cycle and statistical behavior of the unwanted signal. In some embodiments transmitter is the access point (AP) (or base station (BS)) of a cellular system and the receiver is a user terminal (UT), also known as the user equipment (UE), the mobile or portable. This configuration is termed “intra-cell interference mitigation”. In some other embodiments, the whole network or a part of the network (represented by a number of cells in a cellular network) is supported by an Interference Controller Node (ICN), different than the AP (and UT) node(s), dedicated to the interference reduction in a network or set of networks in a specific geographical area. This configuration is termed “inter-cell interference mitigation”.

In some embodiments, the task of interference mitigation is combined with the self interference mitigation strategies used at the AP of a multi-user system to reduce the effect of interference on the victim UT node. This method can be targeted to either or both intra-cell and inter-cell interference mitigation techniques. In some embodiments, the knowledge of interference power is used by the access point to determine resource allocation strategies used in a point to multipoint transmission scenario such as TDMA (time-division multiple access) or broadcast based on the DPC (dirty paper coding) [see Ref. 11].

In some other embodiments, once the interference is detected, a set of messages are communicated to the victim receiver node to adjust its interference mitigation parameters and/or strategies or inform the receiver node of characteristics of the new interference scenario such that it can adjust its interference mitigation parameters and/or strategies accordingly. This method can be applied to either or both inter-call and intra-cell interference mitigation. For example in CAMA/CA-based systems such as WLAN, the interference mitigation parameters may include the size of back-off window, among other parameters.

Various methods can be used for interference detection. These methods are established through different techniques that can be specialized for each specific wireless network. This includes for example different flavors of spectral sensing as part of the cognition process in a radio [12] leading to energy detection, and/or, other measurements such as estimation of the statistics of an uncoordinated interfering signal. In some embodiments, once the interfering signal statistics are known, this knowledge can be used to update the channel state information (CST), in order for the victim node to adapt its interference mitigation strategies according to the current and/or upcoming interference (directly and/or indirectly). In some other embodiments, the interference is detected indirectly through measurement of the interference parameters such as SNIR (signal to noise plus interference ratio), or a change in the SNIR, at the receiver and communicating it back to the transmitter thorough a feedback channel.

In some embodiments, the above interference detection information is used to influence the precoding mechanism at the AP transmitter. In particular, the interference signal information (including is power, statistics, frequency, bandwidth, etc.) can be used to redefine the precoding mechanism used at the transmitter for the self interference (or multi-user interference). In some embodiments, the indirect interference parameter measurement is performed at the receiver and communicated back to the transmitter through a feedback channel. This can be used to modify the channel state information (CSI) that is fed back to the MAC layer, to aid resource allocation strategies, through a cross-layer approach.

In order to avoid unnecessary false alarms and speedup the feedback channel information (e.g. SNIR), in some embodiments, a combination of the indirect measurement of interference based on interference parameter computation at the receiver and a direct interference measurement method based on methods such as directional spectral sensing at the transmitter is used.

In some embodiment interference parameters (e.g. its statistics, bandwidth, duty cycle, etc.) is communicated to the receiver (e.g. on a control channel) to help the victim node adjusts its interference mitigation strategy and/or parameters locally. To reduce the messaging signaling overhead, in some other embodiments, the interference parameters are processed at the interference measuring node (e.g. AP or ICN) and a set of interference mitigation parameter updates are communicated to the victim node (e.g. UT or AP). In certain variants (inter-cell interference mitigation when the AP or BS interference is addressed), the interference parameters or interference statistics are directly communicated by the ICN to the AP or BS, through a set of messages. On the other hand, in other variants (when UT or UE interference mitigation is addressed), these set of messages are relayed to the UT or UE through the serving AP or BS.

For example in a WLAN network with intra-cell interference mitigation when carrier sensing is used to mitigate the interference (Carrier Sensing Multiple Access with Collision Avoidance, or CSMA/CA, used in WLAN standards), the interference statistics data can be used by the AP to change the default parameters of the receiving node's CSMA/CA. This includes the changing back off window size definition for the receiver, based on the access point interference detection and/or its prediction.

In various intra-cell interference mitigation systems, the transmitter evaluates the significance of interference impairments on the receiver (victim mode). In some embodiments the knowledge of the interference zone of the receiver is obtained through a series of measurements and analysis at the transmitter. In inter-cell interference mitigation systems, the ICN node evaluates the existence and significance of interference on the victim mode (e.g. AP and/or UT). In some embodiments this knowledge is also used to adjust the interference sensing requirements of the interference detector node. This includes, but not limited to range (sensitivity) and/or direction (angle of) interference sensing in order to furnish the concept of “spatial spectral sensing”.

In some embodiments the interference detector node can estimate whether there is a potential for interference misdirect at the UT (or UE) prior to interference detection (e.g. application: A WLAN network CSMA/CA and RTS/CTS handshake), After it is decided that there is a potential for an interference that may not be detected by the receiver, an interference detection process is initiated. After interference detection process the outcome determines the correct course of action for interference mitigation.

In various embodiments the range and direction of the transmitting node's interference sensing mechanism is controlled through smart antenna techniques. In some embodiments a simple beam switching strategy (e.g. using a Butler Matrix [see Refs. 13,14] to generate a multibeam pattern) is used to detect the interference signal along with some location attributes of the interferer such as its coarse angular location, the affected terminal(s) and/or access points. In some embodiment an adaptive array can be used to establish a more accurate sensing of the power and angular position of the interference signal along with its other location attributes.

In another aspect of the invention, an optional trigger mechanism for the interference detection/mitigation process is disclosed. In one embodiment, this trigger is accomplished through estimation of potential for interference mitigation (e.g. by spotting an interference or interfere in a hidden node zone of a receiver, so that there is a potential for it to be missed when employing only standardized prior art protocols).

In another aspect of the invention, a carrier sensing region is extended through use of one or more different techniques, such as e.g., a smart antenna, to be larger than usual transmission range of the transmitting node.

In another aspect, methods and apparatus for the detection of the type and behavior of one or more out-of-network interferers are disclosed.

In another aspect, methods and apparatus for the allocation of resources at AP that can be affected by the level of interference at the client (or UT), e.g., modified DPC, are disclosed.

In another aspect, methods and apparatus for the change of CSMA (or MAC/other layer) parameters at a UT through measurement and computations relating to an AP, or alternatively measurement at an AP, and computation at the UT, are disclosed.

In another aspect, methods and apparatus for interference zone analysis and selective interference mitigation are disclosed.

In another aspect, methods and apparatus for the enhancement of network security aspects based on interference detection and mitigation are disclosed.

### BRIEF DESCRIPTION OF THE FIGURES

The invention described herein, is detailed with reference to the following figures. The attached drawings are provided for purposes of illustration only and only depict examples or typical embodiments of the invention. It should be noted that the illustrated regions are just examples and regions can take any shape including a circle (i.e., a constant range in all directions). Also, it should be noted although illustrations are shown in 2D, in general, the zones are three dimensional. It also should be noted that for clarity and ease of illustration these drawings are not necessarily made to scale.

FIG. 1A is a graphical representation of an exemplary intra-cell example scenario showing the transmission range of an access point (AP) with radius R_{Tx}(AP) and the transmission range of a user terminal (UT) with radius R_{Tx}(UT) in a cellular communication system. This figure represents an AP-UT distance for which the transmission range of the UT is equal to the interference range of the UT, i.e. R_{Tx}(UT)=R_{I}(UT).

FIG. 1B is a graphical representation of an exemplary an intra-cell example scenario showing the transmission range of an access point (AP) with radius R_{Tx}(AP) and the transmission range of a user terminal (UT) with radius R_{Tx}(UT) and the interference range of the UT, R_{I}(UT) in a cellular communication system. This figure represent an AP-UT distance for which the UT interference range is larger than its transmission range of the UT, i.e. R_{I}(UT)>R_{Tx}(UT).

FIG. 1C shows the same cellular transmission coverage scenario as FIG. 1B, and an uncoordinated interferer 156, located in the hidden node zone, or undetectable interference zone 152 of the UT. The interferer has a transmission coverage area 158 that covers the UT. The figure shows a scenario in which the access point's carrier sense range is the same as its transmission range, i.e. R_{CS}(AP)=R_{Tx}(AP), and is not large enough to sense the interferer.

FIG. 1D shows the same cellular transmission coverage scenario as FIG. 1B, and an uncoordinated interferer 176, located in the hidden node zone, or undetectable interference zone 172 of the UT, The interferer has a transmission coverage area 178 that covers the UT. The figure shows a scenario in which using smart antenna techniques the access point's carrier sense radius is larger than its transmission range, i.e. R_{CS}(AP)>R_{Tx}(AP), such that it is large enough to sense the UT interferer at the AP.

FIG. 1E shows a cellular transmission coverage scenario as FIG. 1D, wherein the carrier sense radius R_{CS}(AP) is extended to sense the interferer by beam switching methodologies such as e.g., a Butler Matrix.

FIG. 2 shows an inter-cell example scenario showing the carrier sense range of the interference control node (ICN) 220 with radius R_{CS}(ICN), the transmission range of an access point (AP) with radius R_{Tx}(AP) and the transmission range of a user terminal (UT) with radius R_{Tx}(UT) and the interference range of the UT, R_{I}(UT) in a cellular communication system. This figure represents an AP-UT distance for which the UT interference range is larger than its transmission range of the UT, i.e. R_{I}(UT)>R_{Tx}(UT). In this example the carrier sense zone 222 with radius R_{CS}(ICN) is extended to include the hidden node interference zone through beam switching techniques.

FIG. 3 shows an example hierarchy of the centralized interference mitigation techniques 300 according to one embodiment of the invention, including various possible methodologies and the required steps in each approach. It includes two main branches of intra-cell 302 and inter cell 332, each of which consisting the interference detection and correction methodologies proposed herein.

FIG. 4 shows an example block diagram for the apparatus proposed in this invention. The device is shown at three different levels of interfaces, namely, the PHY 420 (physical layer), the MAC & DLC 410 (Media Access Control and Data Link Layer) and the Higher Layers 400 (such as network, session presentation and application layers).

### DETAILED DESCRIPTION OF THE EXEMPLARY EMBODIMENTS

Introduction: Co-channel interference is an important factor in determining the overall performance of a wireless network. In particular coverage, capacity, spectral efficiency, and throughput of a wireless network can be adversely degraded in presence of co-channel interferers, if the effect of interference is not properly addressed in the network design. Examples of the sources of co-channel interference in a cellular network include other users in the same cell, other cells, as well as, unintended and uncoordinated interferers. Many types of cellular networks and in particular WLAN, WMAN and WWAN share the same design challenge in that they are formed of many radio access points or base stations (depending on the network type, numbering from a few to hundreds and even thousands of transmitters in a network), each addressing a relatively small area, in order to provide coverage for larger areas. To address the inter-cell co-channel interference problem spatial/frequency domain separation strategies are used based on the frequency reuse concept. More specifically, most networks deploy access points using a different RF channel or frequency for each transmitter. To accommodate this, neighboring access points using different RF channels particularly in areas where cells overlap (in fact the access points on the same channel are located as far apart as possible). This frequency reuse can also be implemented on sector level within a cell. Frequency reuse requires hand over at the cell boundaries which for some networks such as WLAN is a costly investment. The intra-cell interference usually generated by the users in the same cell (or sector) is addressed through a number of PHY techniques such as interference cancellation, channel coding, space-time coding and in particular MIMO. These techniques can also reduce the inter-cell interference. Another important technique deployed in wireless systems like WLAN (802.11b, a, g and n) is carrier sense multiple access with collision avoidance CSMA/CA in conjunction with a handshake called RTS/CTS [see Ref. 15]. In this scheme, before each transmission, the transmitting node performs a carrier sensing by performing an energy measurement in the transmission channel. If the detected energy is beyond certain pre-defined threshold, the node assumes that there is another transmission on the channel and randomly backs off from transmission (by setting a decrementing counter to a random number and transmit when the counter rests). A second level of interference/collision avoidance is provided through the request to send and clear to send handshake (RTS/CTS) to inform the transmitting node on the clarity of the channel before transmission. This mechanism can potentially eliminate the so-called hidden node problem generated by nodes that interfere with a receiver, but cannot be detected during the CSMA/CA. The underlying assumption for the above process to be effective is that the hidden node is outside the transmission range of the receiver, but it includes the receiver's interference range (even if it is beyond both the transmission and interference range of the transmitter).

Application: This invention is targeted at addressing the co-channel interference problem when implementation of the standardized and conventional methodologies are not possible, not effective, inefficient or not sufficient (e.g. for support of the application's QoS). There are in fact a number of likely implementation scenarios that could result in these situations. Each of followings scenarios or their combination are examples of our intended application:
Frequency reuse in not preferred, possible or feasible: In situations where the handover is either not implemented in the user terminal or the network does not support handover altogether, frequency reuse is not a preferred option. For example when the UT is not involved in any handover decision, the network faces the challenge of directing traffic to a moving UT via the nearest access point with available capacity. A single RF channel in this case is an attractive solution as it eliminates the need for a handover mechanism involving the client. In addition if there is no frequency reuse, the traditional channel planning required for cellular networks is not needed, giving rise to more bandwidth available to each user.
The network receives co-channel interference from uncoordinated neighboring cells: This scenario can happen in uncoordinated neighboring networks located in a dense geographic area. For example WLAN users in a multi-dueling unit or apartment building set their WLAN networks completely independent from one another. Although the users can select from a number of operating channels, it is still likely that two networks using the same RF frequency be close enough to interfere with each other. In such cases, if the transmission area of the receiver is smaller than interference area of the transmitter, it is possible that the hidden node problem is not completely addressed by the CSMA/CA and RTS/CTS handshaking mechanisms, resulting in significant throughput degradation.
The RF spectrum is unlicensed: Different devices sharing unlicensed bands can potentially interfere with one another in many possible scenarios. For example WLANs at 2.4 GHz ISM band (e.g. 802.11g) share the spectrum with other ISM devices including microwave ovens and cordless telephones (e.g. the frequency hopping WDCT phones). These interferers, with radiated powers comparable to the WLAN equipment can easily confuse the CSMA/CA protocol which usually detect energy but do not interpret the interference characteristics.
The network is operating in “White Spaces” spectrum: The so-called white spaces spectrum refers to frequency bands allocated to a broadcasting service such as terrestrial TV, but is not used locally. In the United States, these ranges of frequencies gained attraction after the FCC ruled that unthreatening unlicensed devices, i.e. devices that can guarantee that they will not interfere with assigned broadcasts can use the unused white spaces in spectrum. Recently different wireless standards have shown interest in using this band. In particular, WLAN white spaces deployment also known as “Wi-Fi on steroids” (referring to the fact that the radio wave propagation in these spectrum have much longer range than extant Wi-Fi technology) has recently gained significant momentum. More specifically, usage of the white spaces' lower frequencies (few hundreds of MHz) results in a wireless network spread using fewer base station, hence lower network deployment costs. At the same time however, the white spectrum can suffer more from neighboring network or other unlicensed interferes (as compared to the higher frequencies used in WLAN, WiMAX, etc.), due to the very reason that makes it attractive, i.e. the larger coverage ranges. In addition to the interference mitigation of other whitespace users, the interference mitigation and/or avoidance methodologies proposed in this invention can help preventing the unlicensed spectrum to harm the broadcasting services.
The network is ad hock: In an ad hoc network, the hidden node can become a serious problem depending on the interference mitigation methodologies used. For example in WLAN networks using CSMA/CA with RTS/CTS signaling, due to the large distribution of mobile nodes and the multihop operation, the hidden node problem raises frequently.
The radio link traffic has QoS requirements that impose extra interference sensitivity to each transmission. Multiuser terminal heterogeneous networks with multitudes of traffic types and QoS requirements, are increasingly being adopted by service providers. High speed real time traffics involving image or motion picture communications (e.g. HDTV) are in particular very sensitive to the fading and interference disturbances observed in a wireless network. For example, studies have shown [16] that the throughput of the new generation of WLAN (802.11n) supporting live HDTV channels can be quickly reduced to the extent that the application cannot be supported, if the SNIR is reduced beyond certain threshold (due to fading as well as interference effects). In addition, in many scenarios it has been shown [see Ref. 16] that the radius ratio of the interference region to the transmission region in a node is a function of minimum allowed SNIR, as the SNIR requirements for specific services (e.g. HDTV) increase, the likelihood of having interference regions beyond the transmission region increases, resulting in the hidden node interference problem.

It should be noted that the above scenarios are example scenarios and the effectiveness of the interference mitigation methodologies stated herein is not limited to the above scenarios.

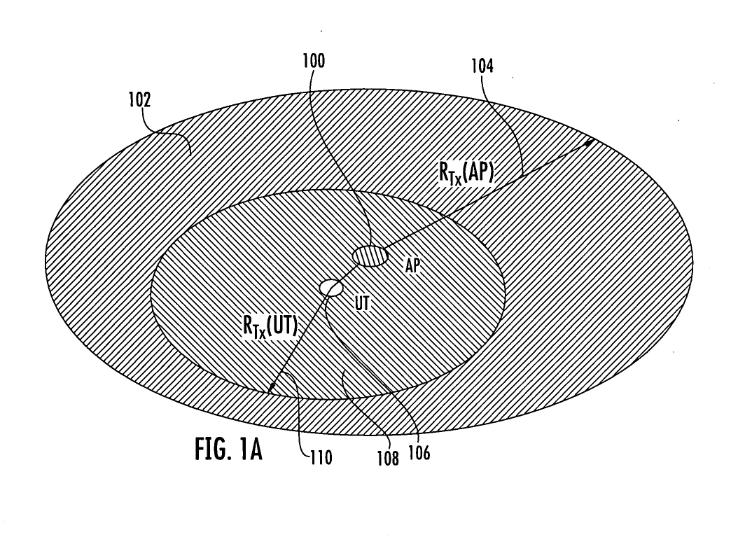

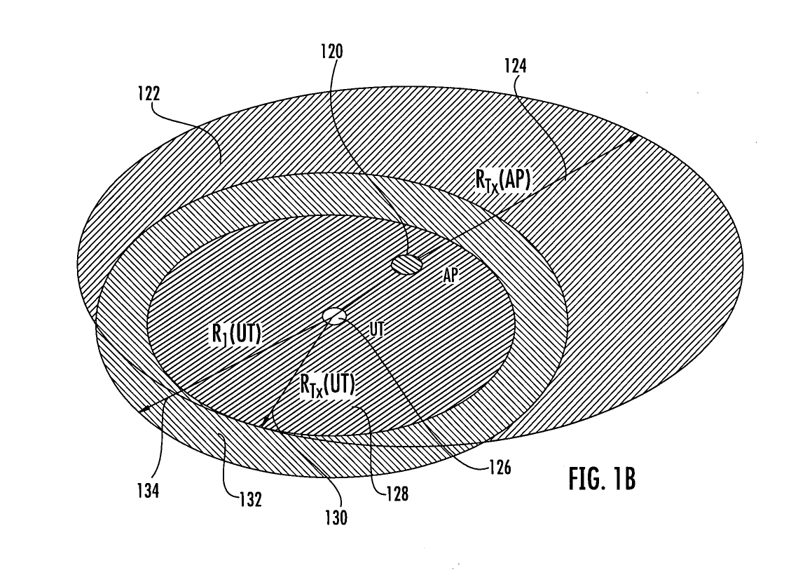

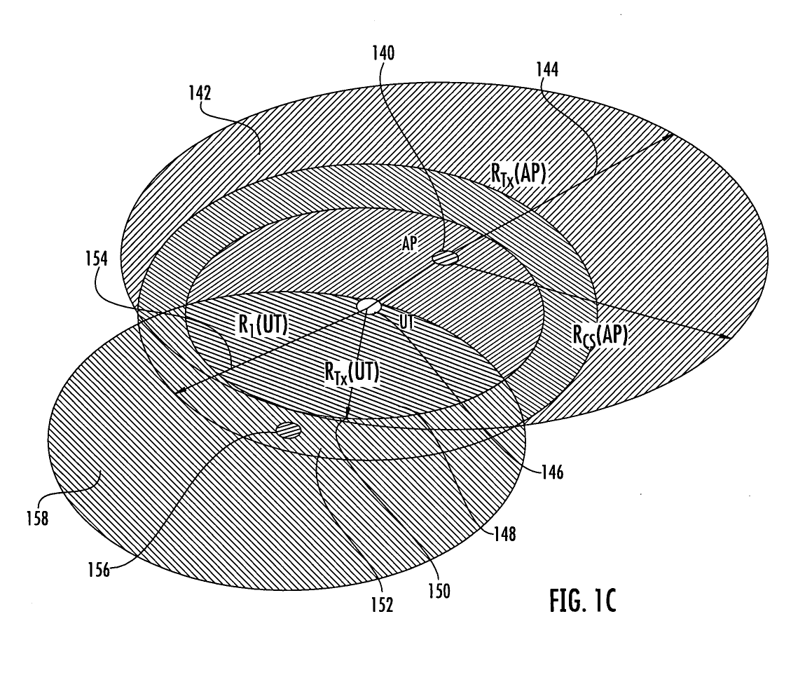

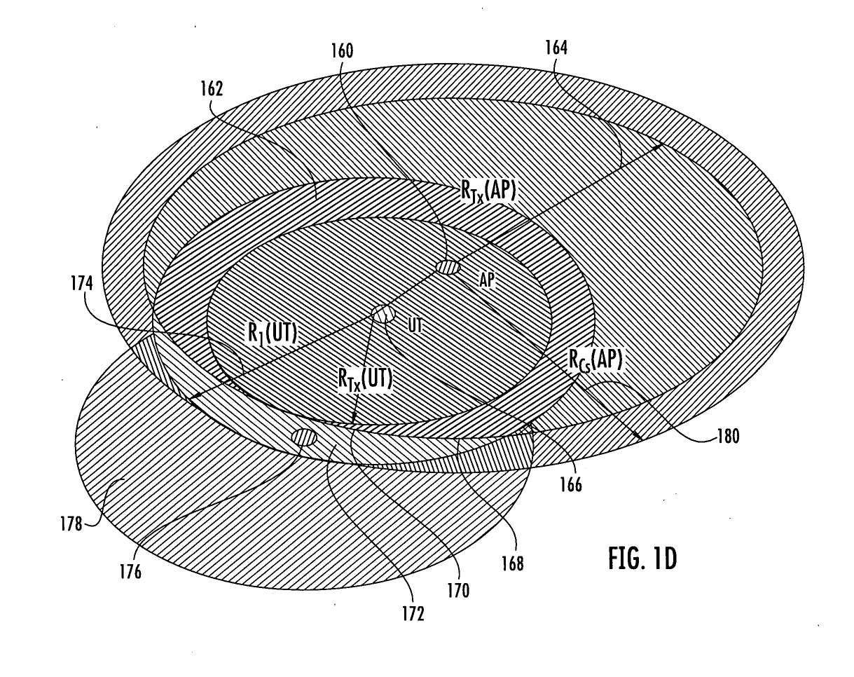

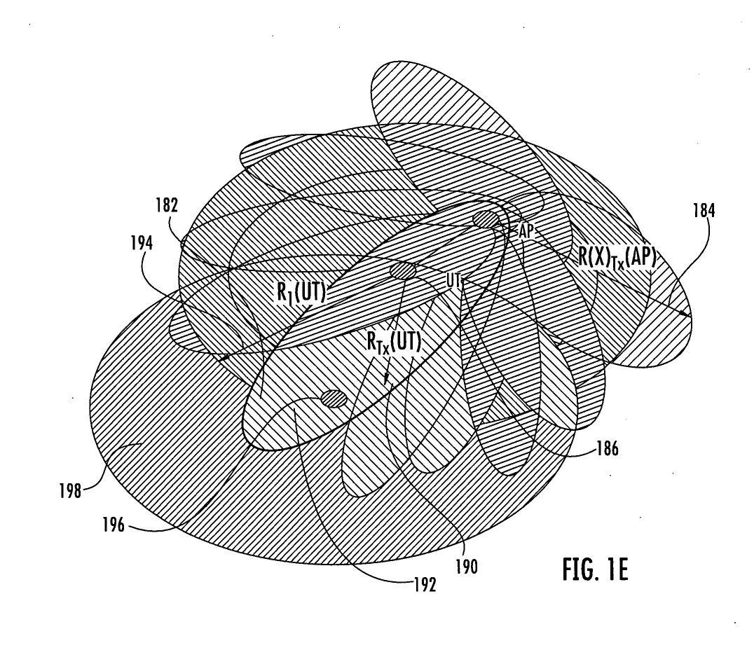

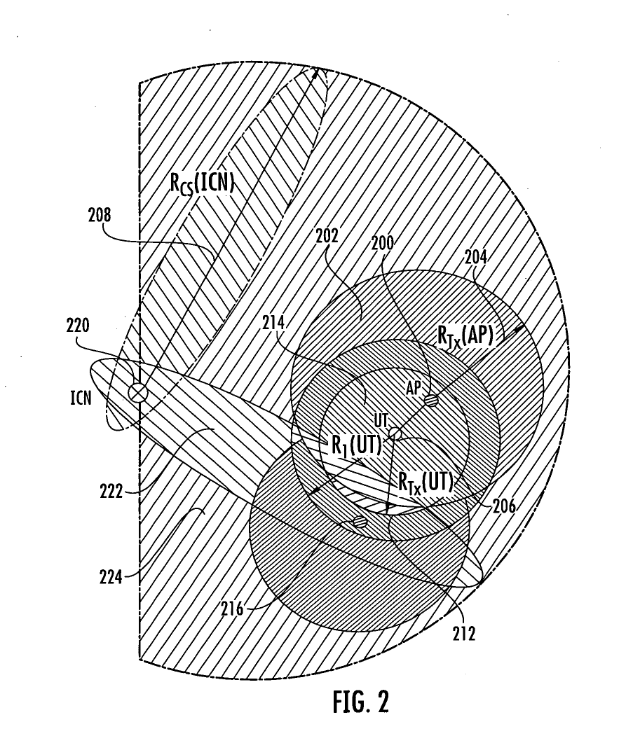

To better clarify the undetected hidden node problem in a WLAN network, FIGS. 1 and 2 illustrate different examples uncoordinated interference scenarios in a cellular network (like WLAN) with various coverage and interference scenarios. In particular FIG. 1 gives examples of intra-cell interference mitigation, while FIG. 2 illustrates an inter-cell mitigation scenario. We define the following parameters:
1. R_{Tx}(AP) is the AP transmission range or the distance within which the access point transmission can be received and detected in the absence of interference. This range is usually determined by the radio propagation channel attenuations and the AP Tx power. Note that in general R_{Tx}(AP) can vary at different directions (or angles). Also when multipath fading is present the AP transmission range varies with time. In general R_{Tx}(AP) is considered in an average sense.
2. R_{Tx}(UT) is the UT transmission range or the distance within which the user terminal transmission is detectable in the absence of interference. Again this range is a function of the radio propagation channel attenuations and the UT Tx power. Note that in general R_{Tx}(UT) can vary at different directions (or angles) and time (in fading channels), therefore in general R_{Tx}(UT) is defined in an average sense.
3. R_{I}(UT) is the UT interference range or the distance within which the user terminals in receive mode can be interfered by an unrelated or uncoordinated interferer and suffer a performance loss. Again, in general, the R_{I}(UT) is considered is an average sense.
4. R_{CS}(AP) is the access point carrier sense range, i.e. the range over which a transmitter triggers a carrier sense decision at the AP and is usually determined by the AP antenna sensitivity.
   FIG. 1A shows a scenario that the interference is always detectable. In this case the AP 100 is close enough to the UT 106, such that there is no potential for undetected interferer at the UT that can escape the CSMA/CA with RTS/CTS handshake process. Therefore R_{Tx}(UT) and R_{I}(UT) can be considered equal and the UT can appropriately sense and avoid the co-channel interference created by other uncoordinated UTs and/or other cells (i.e. the interference from an adjacent cell or network). FIG. 1B shows a scenario in which the UT 126 is farther away from the AP120, so that R_{I}(UT)>R_{Tx}(UT). That is, the transmitted signal from access point is attenuated to a level that an interferer beyond the R_{Tx}(UT) can hurt the reception of the AP transmission at the UT. In general the relationship between R_{Tx}(UT) and R_{I}(UT) is determined by the AP-UT distance “x”, the equivalent path loss (or decay law) index (attenuation of signal with distance) of the channel and the SNIR threshold (or SNR threshold). It is noted that in multipath channel, the transmitted signal power usually decays with an exponent larger than square of the distance (used for free spaces). The SNIR (or SNR) threshold is the minimum level of SNIR (or SNR) at the receiver for a specific performance requirement. In general, in a WLAN environment, the signal attenuation with distance or path loss exponent ranges anywhere between power of 1.5 to 6 [see Ref. 17], depending on various parameters such as the Tx-Rx distance, building material, floor layout, and frequency of operation.

Example: The following is an example computation of R_{I}(UT) as a function of the AP-UT distance for two different services based on the knowledge of the SNR threshold and the path loss index. Assuming a path loss index of 4.5 and similar antenna fixtures for the AP and potential interference source it easy to show that:

$${R}_{I} ( UT ) = \sqrt[4.5]{{SNR}_{T}} * x \\ where \text{:} \\ {SNR}_{T} \text{:} Is the Threshold SNR , \\ x Is the TX \text{-} Rx Distance \qquad Eqn . ( 1 )$$

Now two services with service 1 requiring a SNR_{T1} of 10 (e.g. Data) and service 2 requiring a SNR_{T2} of 30 dB (e.g. HDTV) we have:

$$ForSerivce 1 \text{:} \\ {R}_{I 1} ( UT ) = \sqrt[4.5]{{SNR}_{T 1}} * x = \sqrt[4.5]{10} * x = 1.67 x \\ ForSerivce 2 \text{:} \\ {R}_{I 2} ( UT ) = \sqrt[4.5]{{SNR}_{T 2}} * x = \sqrt[4.5]{1000} * x = 4.64 x , \\ x Is the TX \text{-} Rx Distance \qquad Eqn . ( 2 )$$

Therefore the harmful interference range can be almost tripled if the traffic changes from a low SNR requirement service like data to a high SNR threshold service like HDTV.

FIG. 1C shows an outside interferer 156 located in the undetectable interference zone 152, defined as the portion of the interference region which is outside both the UT transmission area 148 and the AP transmission area 142. In this case a node 156 can escape the CSMA/CA at AP associated with the RTS/CTS handshake (it becomes a hidden nodes), causing potentially significant degradation of the AP 140 to UT 146 transmission.

In networks with well defined transmission and interference region boundaries (e.g. in presence of a strong line of sight (LOS) between AP and UT), the transmitting node can compute, with a good certainty, the boundaries defining the undetectable interference region thereby determining whether there is a potential for interference misdetection at the UT before any decision is made on interference detection. This is performed by computing R_{Tx}(UT) and R_{I}(UT) based on the knowledge of SNR threshold and path loss exponent as shown in the above example. After it is decided that there is a potential for an interference that may not be detected by the receiver (UT), an interference detection process is initiated at the transmitter. After interference detection process the outcome determines the correct course of action for interference mitigation.

Centralized Interference Mitigation Strategy: We propose a centralized interference mitigation strategy that can consist of a number of different methodologies. This centralized approach can be interpreted as assigning a specific unit (other than the receiver) to the interference detection in cellular wireless networks (e.g. as opposed to making the user terminal involved in interference detection). In some embodiments this centralized unit can be the access point (AP) or base station (BS), hence the name intra-cell interference mitigation. In some other embodiments this centralized unit can be a dedicated unit targeted to interference detection and cancellation using the required signaling, hence the name inter-cell interference mitigation. FIG. 1 gives examples of intra-cell interference mitigation, while FIG. 2 illustrates an inter-cell mitigation scenario. Although not directly obvious from the naming inter-cell, in some embodiments interference cancellation can be based on addressing interference received from within the cells of a network or cells belonging to multiple networks. In some embodiments these steps or a subset of them can be tailored to a specific application based on a number of parameters including, but not limited to, the channel type, the nature of interference, the PHY and MAC design, the type of services, and the spectral efficiency of the network. These techniques can be categorized into the following:

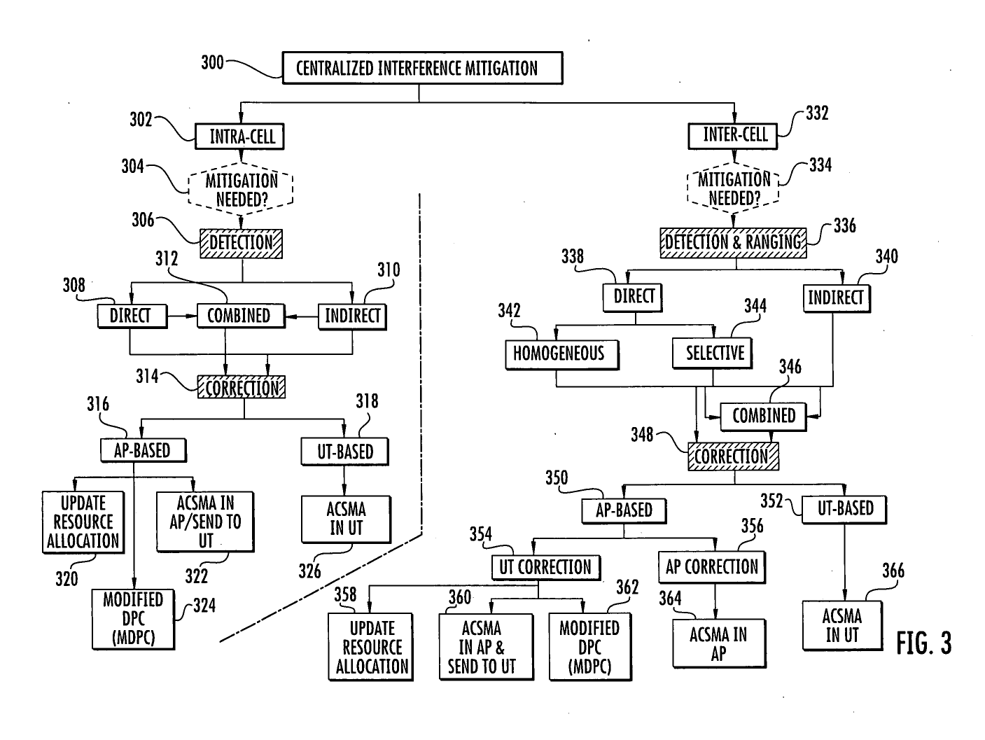

Interference Mitigation Approaches: In various embodiments the interference mitigation topology determines the centralized interference mitigation approaches that can be used. FIG. 3 details different interference mitigation topologies and the related interference detection and mitigation options. The interference mitigation topology can be categorized by two major types, the intra-cell interference mitigation 302 and the inter-cell interference mitigation 332.

In summary, a cross-layer approach to network design aims at enhancement of the system performance by jointly designing multiple protocol layers (or at least, enhance the communication between them) The main benefit of this approach is that it allows upper layers to better adapt their strategies to varying link and network conditions resulting in extra flexibility helping to improve the network's end-to-end performance. These design concepts are particularly useful for supporting delay-constrained applications such as streaming video.

Realization of a complete cross-layer concept in network design can significantly increase the design complexity. To simplify matters, some implementations focus on cross layer optimization of specific layers that have a dominating role in determining the overall system performance. In particular, among different layers, the main focus is on the cross-layer approaches encompassing MAC/DLC and PHY Cross-Layer designs for optimization or resource allocation strategies [see Refs. 8, 9].

The crucial role of PHY and MAC layers in the optimal design of cellular wireless networks is evident from the nature of the communications required. In a multi-user system, each wireless transmission targeted at specific receiving node can be heard by neighboring nodes which is perceived by them as interference (or self interference). As a consequence, there is a need for a more complex medium access mechanism. On the one hand, the MAC design should be able to control the amount of interference at the receiver. On the other hand, the MAC should exploit an optimal combination of available resources such as special multiplexing and spatial diversity, in order to maximize the performance and in particular, the network's spectral efficiency. It is noted that since MAC design controls the level of average interference (including interference from other users or self interference) present in the network, it influences the performance of the physical layer. For example if the total amount of the interference at a receiver during a reception of a packet is large, the physical layer should decrease the transmission rate using an adaptive modulation and coding scheme (AMC), if available. On the contrary, if the interference is and noise levels are low, the PHY layer should deploy a more suitable modulation and coding to make the best of the condition (i.e. by increasing the coding rate and/or using higher constellations) to transmit a high rate. Another control mechanism specific to wireless networks is the power control which is tightly coupled with both MAC and PHY layers. From these examples it can be concluded that a change in a protocol of the MAC layer will affect the expected performance of the PHY layer and vice versa. Similarly interaction of other layers can affect their performance and hence the system performance. Therefore an optimal protocol stack should be designed by greater coordination and feedback across the layers, hence the name cross-layer.

In parallel with AMC, many recent cross-layer design concepts are based on exploiting multi-user diversity (MUD), the phenomenon of multiple users experiencing independent fading channels. The exploitation of MUD was initially based on the pioneering work presented in [see Ref. 10] for uplink of a single cell. The MUD concept is based on maximizing the sum capacity (defined as the sum of simultaneous user capacities) by scheduling for each time instant, the user that has the best channel condition. The gain achieved by this scheme is called MUD gain which demands a power control law by applying more transmit power to the stronger channels. This is somewhat opposite to the conventional power control strategy, which assigns more power to the weaker channel. For downlink scenario a similar optimization concept is used by MUD, i.e. at each time instance the access point (or base station) scheduler, assigns transmission to the user with the best channel. These cross-layer methodologies, in effect break the traditional isolation between PHY-based and MAC/DLC-based resource allocation strategies which were historically addressed by the information theory field and networking theory field respectively. This is achieved through a MAC resource allocation strategy supported by knowledge of the channel state information (CSI) provided by the PHY layer.

In addition to the conventional MUD, other degrees of diversity that might appear in a multi-user environment may be exploited to improve the system performance. In particular future networks are anticipated to have a high degree of heterogeneity which includes scenarios like multiservice supporting nodes, multi-standard supporting nodes, single antenna users sharing resources with multiple antenna users, etc. This results in terminals or nodes that require specific method of exploiting channel conditions, leading to a concept of networks supporting heterogeneous multiuser diversity (HMUD).

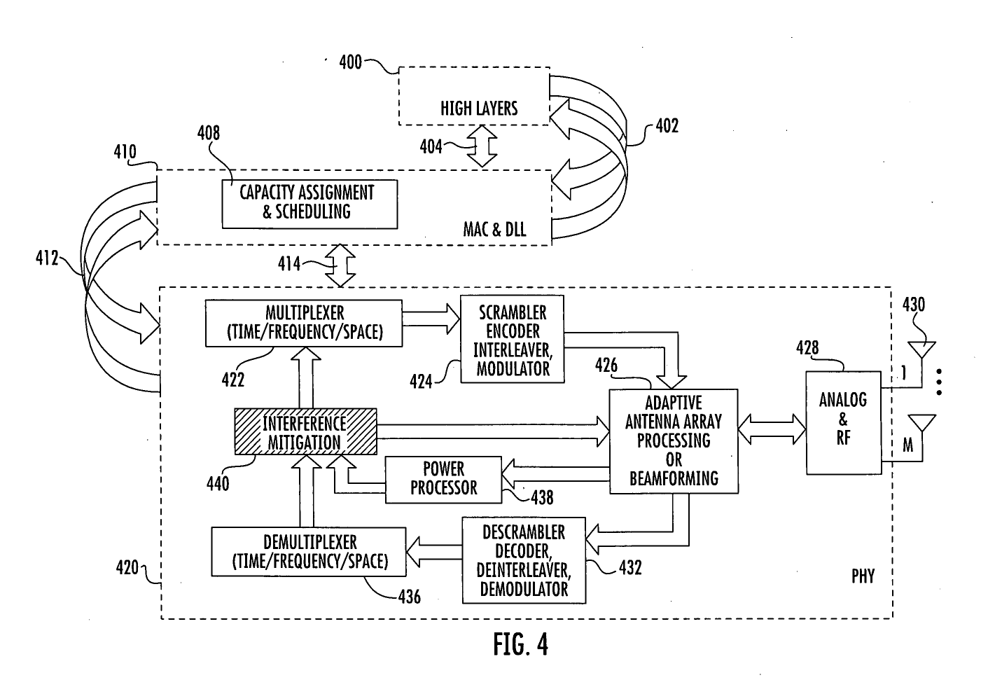

Apparatus Example Block Diagram: FIG. 4 depicts an example block diagram for the apparatus proposed in this invention. In an intra-cell interference mitigation setup, this device can be the AP or BS of a cellular network. In an inter-cell interference mitigation setup, FIG. 4 gives a block diagram example of the Interference Controller Node (ICN) device. The device is shown at three different levels namely, the PHY 420 (physical layer), the MAC & DLC 410 (Media Access Control and Data Link Layer) and the Higher Layers 400 (such as network, session presentation and application layers). 402 and 412 show the “cross-layer” connection between higher layers and MAC/DLC, as well as, between MAC/DLC and PHY respectively. 404 and 414 indicate the standard layer connections based on the OSI model. The PHY layer constitutes of some standard transceiver blocks at the baseband digital, analog, and RF levels. The interference mitigation module 440, is responsible for detection of the interference, as well as, interference correction including support of the processing and the data exchange required for interference correction as stated above. For example in an inter-cell direct interference mitigation scenario the cross-layer connection may be used for the UT interference mitigation, by adjusting the scheduling at the MAC level. More specifically, during interference detection the receiver of ICN in FIG. 4 detects the interference power with desired sensitivity (e.g. using smart antenna techniques in 426). This information is passed to the power processor 438, which as will be explained can perform different computations on the received signal energy, depending on the type of interference and its statistics. In the simplest scenario the power processor measures the in-band RSSI of the interferer and communicates this information to the interference mitigation block 440. The interference mitigation block in turn processes this information and translates it to a signal protocol that through a cross-layer connection can update the resource allocation strategy used in the MAC module 408. Details of the proposed inter-cell and intra-cell interference mitigations are given below:

### (A) Intra-Cell Interference Mitigation:

In this arrangement the access point (AP) or the base station (BS) is in charge of interference mitigation for its own clients (user terminals (UT) or user equipments (UE)), as shown in various examples in FIG. 1. The interference mitigation process can be divided into two steps:
Interference Detection: Referring to FIG. 3 306 this includes the process of sensing, detection and/or characterization of the interference and can be categorized into direct 308 and indirect 310 interference detection. Alternatively, depending on the characteristics of the interference, a combination of both direct and indirect interference detections can be used to enhance the detection reliability. In FIG. 3 this is referred to combined scheme 312.
Interference Correction: Referring to FIG. 3 314 this includes all actions, initiated by the AP, which are necessary to reduce or cancel the interference effect.

Direct Interference Detection: In some embodiments the standardized interference detection mechanism is used by the network (e.g. the CSMA/CA based on a simple carrier sensing used in WLAN) are not considered sufficient and interference is detected by methods beyond those considered in the standard. In some embodiments the interference affecting the UT is directly detected at the AP by spectral sensing including power and bandwidth measurement of the unwanted signal (e.g. by monitoring sudden changes in the average received signal power in different directions). This is achieved by extending the sensing range of the AP towards the interference region of the UT, if required. An example of extension of sensing range is shown in FIG. 1D. As can be seen, the R_{CS}(AP) 180 or the access point carrier sense range is increased (e.g. through improving the AP antenna gain) as compared to FIG. 1C such that it includes the UT interferer 176 located inside the UT interference region 162. In some embodiments, a sophisticated interference detection strategy including interpretation of the interference signals duty cycle and its statistics, traffic patterns, etc. that can potentially result in to a level of predictability in interference occurrence is performed. For WLANs the main motivation behind this centralized approach is twofold. Firstly, it alleviates the need for RTS/CTS handshaking, and reduces the signaling overhead. Secondly, it can detect interference in the hidden node zone (see zone 152 in FIG. 1c) that the so-called RTS/CTS handshake is not capable of supporting, thereby adding more interference mitigation power to the network. In addition as mentioned above, unlike SCMA/CA which generally detect energy levels but cannot distinguish or interpret the interference characteristics, information such as the framing, bandwidth, traffic patterns, etc. can be measured and recorded so of which can also add predictability to interference detection methodology. FIG. 1E shows a cellular transmission coverage scenario as FIG. 1D. The only difference is that the carrier sense radius R_{CS}(AP) is extended to sense the interferer by beam switching methodologies such as Butler Matrix.

Indirect Interference Detection: In this approach the interference is not measured or directly detected at the AP or base station. Instead, the existence of an interferer source can be established indirectly and the interferer power at the UT can be measured through close monitoring of the UT received interference characteristics such as SNIR. In some embodiments this can be established through a fast feedback channel communicating the interference parameters measured at the receiver of UT back to the AP. In some embodiments, an averaging is performed on the measured interference parameter(s). For example the SNIR monitoring can be performed by establishment of a temporal average of SNIR over a sliding sample window with a size determined by the coherence time of the channel. Once the SNIR variations are consistently above certain threshold (this threshold may be defined through the average expected SNR), the AP concludes that an interferer is affecting the UT. In some other embodiments, where the channel state information (CSI) is communicated by UT back to the AP the SNIR computations are incorporated to the CSI messaging at the UT and then communicated to the AP.

Many methods for interference detection have been proposed in the literature (see e.g., Refs. 12, 18, and 19). In general the interference detection mechanism can be tailored to match the wireless network characteristics and the nature of interference.

Referring to FIG. 3, in some embodiments, the AP may use an indirect 310 interference detection methodology (e.g. based on interference parameter measurement(s) such as SNIR) to measure the interference power P_{I}(UT) as seen by the UT receiver. This method is particularly attractive in scenarios where the co-channel interference of neighboring uncoordinated cells and or networks is the only interference that be addressed.

In some other embodiments where the co-channel interference due to neighboring uncoordinated cells is not present or it not is the only interference that needs to be addressed, the AP may use a direct interference detection methodology (FIG. 3, 308) to measure the interference power P_{I}(AP) at the AP. These mechanisms are determined by the type of interferer and in many cases the interference predictability can be used for its correction (as well as detection). It is noted that in the absence of proper interference mitigation strategy, these interferers can easily confuse the WLAN's CSMA protocols (which detect the energy, but do not interpret its characteristics) resulting in frequent random back-offs and hence serious throughput reduction that may cause failure of the QoS requirements.

Combined Interference Detection: Referring to FIG. 3 some embodiments use a combined interference detection approach 312. More specifically, in order to avoid unnecessary false alarms and speedup the feedback channel interference information, in some embodiments, the indirect measurement of interference measurement based on SINK computation at the receiver may be combined with a direct interference detection method based on directional spectral sensing at the transmitter, resulting in a combined interference detection approach. In some embodiments, through monitoring variations in the short-term averages of the SNIR one can confirm a new average SNIR to be used for the precoding at the transmitter, if existence of an interferer is confirmed by the spectral sensing at the transmitter. In some other embodiments in addition to the detection of interference by the direct method, the interference power at the detecting AP is translated to the interference power measurement or SNIR measurement as seen at the victim UT, through indirect interference detection. As will be seen below, this measurement enables the AP controlled mechanisms for downlink interference mitigation and/or improvement of the spectral efficiency (such as precoding, MAC scheduling, etc.) to benefit from the knowledge of interference measurements at the UT in appropriately adapting their algorithms.

One of the interference sources that can harm the WLAN transmission at both 2.4 and 5 GHz bands is the cordless telephony. Modern cordless phones such as DECT (digital enhanced cordless telephony) or WDCT (worldwide digital cordless telecommunications) employ frequency hopping spread spectrum techniques to minimize their interference to one another, but since they do not perform any CSMA/CA procedure they can appear as narrow-band interferes to the WLANS (with a bandwidth that interfere with 10% of the WLAN bandwidth in worse case). In some embodiments an interference detection mechanism that takes advantage of the narrow-band characteristics of interferer detects this signal and inform the AP to perform appropriate action. A simple Auto Regression (AR) modeling can be used for detection which performs spectral smoothing of the interference, reducing the measurement noise effect (e.g. [20]). In some embodiments the interference detector at AP compares the average spectral power measurement (e.g. the output of AR filter) with a threshold to decide whether to declare interference detection. In some embodiments, once the interference is detected its bandwidth and statistical behavior can be computed at the AP (if required by the interference mitigation approach). In some embodiments the hopping sequence can be acquired and the probability of hitting the spectrum can be computed. This adds predictability to the interference detection mechanism that may be used at the interference mitigation stage. Some of these methodologies can be used for other interferes such as microwave oven at 2.4 GHz. Microwave ovens are well-known source of interference in 2.4 GHz ISM band and their radiation has been extensively studied in the literature (e.g. see Ref 21). In general microwave ovens emit somewhere between 35-50% of one AP period cycle [see Ref. 21]. In some embodiments where WLAN is operating at 2.4 GHz band, the AP measures the emitted power and synchronizes itself to the microwave oven on-off cycle, such that the interference presence and absence can be predicted and hence mitigated.

Interference Correction: In various embodiments once the interference is detected by the AP, depending on using direct, indirect interference detection or their combination, its effect on the AP transmission to the UT reception is corrected or reduced using methodologies implemented at the AP, FIG. 3, 314. These methodologies can be categorized into AP-based 316 and UT-based 318 corrections.

AP-Based Correction: In AP-based correction 316, the knowledge of the interference at the AP can affect the interference mitigation robustness of the UT. In some embodiments, the resource allocation strategy at the AP is updated upon presence of interference as shown in FIG. 3, 320. For example, when MUD is used, the order of channel assignments to different users is affected by the interference presence such that the affected nodes obtain lower priorities in the resource allocation process. This in effect is a cross-layer approach where through measurements at the PHY, the MAC-based resource allocation is adjusted. In some embodiments the AP acquires the knowledge of different UT channel states (CSI) required for implementation of the MUD scheduling (allocation of resources based on their spectral efficiencies). Depending on the network and application, this allocation can be based on translation of CSI into a quality level (according to a spectral efficiency function) and then allocating resources based on the computed quality level [see Refs. 22,23]. This approach is listed in FIG. 3, 320. In another embodiment, the effect of interference at the UT is reduced or corrected by updating the interference mitigation and/or avoidance methodologies at the UT. This update is performed through messages from AP providing information that can trigger computation of new sets of interference mitigation parameters at the UT. In CSMA/CA systems like WLAN the UT can change or adapt its CSMA strategy based on the interference detected at the AP. This is termed Adaptive CSMA or ACSMA as shown in FIG. 3, 322. For example back-off window size at the UT is changed based on the information on the interference statistics. In some embodiments the AP obtains an estimation of the timing of existence and absence of the interference during the interference detection phase (e.g. the on-off period of microwave oven radiation or the frequency hopping sequence of a cordless phone). Based on this information the AP may compute a function indicating the probability of interference hits at different time samples (usually a periodic function containing a small number of samples) and provides the UT with this information. Once the UT has an estimate of the interference likelihood as a function of time, it can adjust its back-off window size, such that when the interference is very likely the back-off time is increased, while when the interference presence is unlikely it is decreased. For example the knowledge of a microwave oven emission duty cycle can be contributed to a simple binary function of time that would result in two window sizes at the UT. This strategy can help adjusting the CSMA/CA back off to the interference behavior and can significantly reduce the usually large CSMA/CA overhead.

Example of Resource Allocation: Referring to FIG. 3, in some embodiments, after computation of the SNIR of each user a cross-layer approach is used to perform the resource allocation 320. In some embodiments when a quasi-stationary channel assumption is practical, i.e. the channel H can be assumed to stay unchanged during processing of each frame (or data block of T seconds), the resource allocation policy may be simply defined as “power minus non-multiuser interference allocation policy” such that:

RA(H,I)=Q(H,I)={(P₁−P_{I}_{₁}),(P₂−P_{I}_{₂}), . . . , (Pₖ−P_{I}_{ₖ}), . . . , (P_{K}−P_{I}_{ₖ})}

Q(H,I)={Q₁,Q₂, . . . Qₖ, . . . , Q_{K}}
with a power constraint of:

$${\sum }_{k = 1}^{K} {P}_{k} \leq {P}_{MAX}$$

where,
H is the channelmatrix and is assumed to be constant for a data block duration of T seconds but varies independently every T seconds.
I={I₁, I_{,}, . . . Iₖ, . . . , Iₖ} is the per-user interference vector,
Q(H, I) is the resource allocation vector with elements Qₖ defined as:

Qₖ=Pₖ−P_{I}_{ₖ} for Qₖ>0

Qₖ=0 for Pₖ−P_{I}_{ₖ}<0 Eqn. (3)
where Qₖ represents the amonth that the power per user k, Pₖ exceeds the user k's interference power P_{I}_{ₖ} and Pₘₐₓ is the maximum power budget.
   In some embodiments an optimal resource allocation policy may be used, based on defining a vector of relative priorities such that the optimal resource allocation solution can be computed at the AP. If we defined the vector of priorities as aₖ with Σaₖ=1, with the same approach as in [see Ref. 23] (but using a different resource allocation policy) it can be shown that a theoretically optimal resource allocation policy is computed from:

$$Q ( H , I ) {\vert}_{Optimal} = {arg max}_{Q ( H , I )} ( {max}_{π} {\sum }_{k = 1}^{K} {α}_{k} {R}_{k} ( H , I , Q ( H , I ) )$$

where,

Rₖ(H,I,Q(H,I))=throughput of user k=R_{PHY}^{m}×(1−PER^{m}(SNIRₖ)) Eqn. (4)
where, Q(H, I)|_{Optimal} is the optimal resource allocation policy
m is the constellation size for optimal combination of modulation and coding and
R_{PHY} is the effective PHY rate including coding overhead
PER is the packet error rate.

UT-Based Correction: In this method the effect of interference at the UT is reduced or corrected by using AP to update the interference mitigation and/or avoidance methodologies at the UT. This update is performed through messages from AP providing the information that can trigger computation of new sets of interference mitigation parameters at the UT. In CSMA/CA systems like WLAN, the UT can change its CSMA parameters through the interference information from AP messages. This is termed ACSMA in UT as shown in FIG. 3, 326. For example, back-off window size is adapted to the interference statistics. In some embodiments the AP obtains an estimation of the timing of interference radiation during the interference detection phase (e.g. the on-off period of microwave oven interference or the frequency hopping sequence of a cordless phone). Based on this information, in some embodiments, the UT may locally compute a function indicating the probability of interference hits at different time samples (usually a periodic function containing a small number of samples). Once the UT has the knowledge of interference likelihood as a function of time, it can adjust critical parameters such as back-off window size, such that when the interference is very likely it is increased, while when the interference presence is unlikely it is decreased. The above computation can also be performed at the AP, in which case the AP performs the interference processing and only communicate the computed interference mitigation parameters through signaling back to UT (rather than the UT's local computation).

Incorporation of interference power information into AP precoding of Broadcast Channel (BC): In some embodiments, the knowledge of SNIR can be implemented in broadcast channel communications between the AP and UTs. This method can be categorized under AP-based (FIG. 3, 316) methodologies, as shown in FIG. 3, 324. This method can be used in the AP systems that deploy DPC precoding [11] in their broadcast downlink channels, but instead of standard DPC, modify the DPC coding according to the knowledge of co-channel interference, hence the name Modified DPC or MDPC 324. The MDPC, can be applied to various network types like 3G and 4G cellular as well as other standards like WiFi and WiMAX. In general, in transmission of broadcast channel (BC), when multiple antennas are used at the transmitter (i.e. a dedicated centralized interference canceller in inter-cell mitigation arrangement or AP or BS in intra-cell mitigation scenarios) a multiuser MISO (Multiple-Input Single-Output) channel scenario can be considered. The following summarizes the proposed MDPC algorithm:

MDPC Algorithm Detail: Let us assume that the access point (AP), provided with M antennas, is communicating with K single antenna user terminals (UT). Without loss of generality, let us also assume that the AP acquires the user's CSI (Channel State Information) through a perfect feedback channel. This information is used by the resource allocation algorithm to assign users. The AP transmits a vector s (size M×K) containing each user symbol sₖ. The channel H (size MxK), constitutes a matrix of individual links between each UT and each antenna the AP. Also, without loss of generality, we assume that the UT's have a single antenna. The downlink channel H′ (size K×M) constitutes a matrix of individual links from each AP antenna to each UT terminal (these radio links are assumed to be reciprocal). Assuming a noise vector z and an interference vector I, in the absence of precoding at the AP, the received signal vector is represented by:

y=Hs+z+I

$$[ \begin{matrix}{y}_{1} \\ {y}_{2} \\ ⋮ \\ {y}_{k} \\ ⋮ \\ {y}_{K}\end{matrix} ] = [ \begin{matrix}{h}_{11} & {h}_{12} & … & {h}_{1 k} & … & {h}_{1 K} \\ {h}_{21} & {h}_{22} & … & {h}_{2 k} & … & {h}_{2 K} \\ ⋮ & ⋮ & ⋮ & ⋮ & ⋮ & ⋮ \\ {h}_{k 1} & {h}_{k 2} & … & {h}_{kk} & … & {h}_{kK} \\ ⋮ & ⋮ & ⋮ & ⋮ & ⋮ & ⋮ \\ {h}_{M 1} & {h}_{M 2} & … & {h}_{Mk} & … & {h}_{MK}\end{matrix} ] \times [ \begin{matrix}{s}_{1} \\ {s}_{2} \\ ⋮ \\ {s}_{k} \\ ⋮ \\ {s}_{K}\end{matrix} ] + [ \begin{matrix}{z}_{1} \\ {z}_{2} \\ ⋮ \\ {z}_{k} \\ ⋮ \\ {z}_{K}\end{matrix} ] + [ \begin{matrix}{I}_{1} \\ {I}_{2} \\ ⋮ \\ {I}_{k} \\ ⋮ \\ {I}_{K}\end{matrix} ] \qquad Eqn . ( 5 )$$

where hᵢⱼ is the channel established between the ith antenna of the AP and the jth UT
   It is noted that the interference vector I is established on a per user basis. The precoding at the AP constitutes multiplication of a K-dimensional vector vₖ by the signal vector s. Vectors are in fact the rows of precoding matrix V (size M×K). After precoding is performed at the AP, it can be shown (see Appendix II) that the k-th UT terminal would receive a signal of the form:

$${y}_{k} = {v}_{k}^{T} {h}_{k} {s}_{k} + {\sum }_{{{k}^{′} ∈ Ω}_{{k}^{′} \neq k}} {v}_{{k}^{′}}^{T} {h}_{k} {s}_{{k}^{′}} + {z}_{k} + {I}_{k}$$

where, Ω is the set of active (receiving) users defined as:

Ω={k|kε{1,2, . . . , K}; Pₖ≠0}},

hₖ=[h₁ₖ h₂ₖ . . . hₖₖ . . . h_{Mk}]^{T},

vₖ^{T}=[vₖ₁ vₖ₂ . . . vₖₖ . . . v_{kK}] Eqn. (6)

From the above the SNIR for the user number k, is computed at the AP using the following expression:

$${SNIR}_{k} = \frac{{P}_{{S}_{k}} ( UT )}{{σ}_{{z}_{K}}^{2} + {P}_{{I}_{k}} + {P}_{{MUI}_{k}}} = \frac{{\vert {v}_{k}^{T} {h}_{k} \vert}^{2} {P}_{k} ( AP )}{{σ}_{{z}_{K}}^{2} + {P}_{{I}_{k}} + {\sum }_{{{k}^{′} ∈ Ω ,}_{{k}^{′} \neq k}} {\vert {v}_{{k}^{′}}^{T} {h}_{k} \vert}^{2} {P}_{{k}^{′}}}$$

where Pₖ(UT) is the (averaged) received signal power at the k-th user terminal,
Pₖ(AP) is the (average) transmit power of the signal sₖ,

Ω is the set of active (receiving) users defined as: Ω={k|kε{1,2, . . . K}; Pₖ≠0}} Eqn. (7)

P_{MUI}_{ₖ} is the multiuser interference after precoding and
σ_{z}_{_{K}}² & P_{I}_{ₖ} are powers of the noise and the interference computed at the UT (or AP) usually based on the CSI received in the feedback channel.
When Modified Dirty Paper Coding (MDPC) is used at the AP, the transmitter performs a sequential encoding of the data. The encoding involves pre-distorting the signal targeted to each user k, using the symbols that are sent to the previous users. More specifically, if one assumes an order vector p as a set of orders pᵢ where pᵢ is the i-th order applied to the k-th user, user number k is encoded using the information of users with priorities of p₁, p₂, through, pᵢ₋₁. It is noted that the an important difference between ADPC and DPC is in definition of this order. More specifically, ADPC adds the co-channel interference power associated with external interferers (i.e. the interferers different form the active users in the BC channel) detected at the AP, to modify the encoding order. Similar to the DPC, at each point in time, the first encoded user experiences the interference from all the other users, whereas the last user would not suffer from any user interference. For the k-th user with order pᵢ the interference of all pᵢ₋₁ previous users can be eliminated at each iteration. Based on Eq. 4 and the above, the DPC-encoded received signal for user number k can be expressed by:

$$\begin{matrix}{y}_{k} ( DPC ) = {v}_{k}^{T} {h}_{k} {s}_{k} + {\sum }_{{{k}^{′} ∈ Ω}_{{k}^{′} \neq k}} {v}_{{k}^{′}}^{T} {h}_{k} {s}_{{k}^{′}} - \\ {\sum }_{{{k}^{′} ∈ Ω}_{{k}^{′} ∈ \{ {π}_{1} , {π}_{2} , … , {π}_{i - 1} \}}} {v}_{{k}^{′}}^{T} {h}_{k} {s}_{{k}^{′}} ( DPC ) + {z}_{k} + {I}_{k} \\ = {v}_{k}^{T} {h}_{k} {s}_{k} + { \sum {v}_{{k}^{′}}^{T} {h}_{k} {s}_{{k}^{′}} + {z}_{k} + {I}_{k}}_{{{k}^{′} ∈ Ω}_{{k}^{′} ∈ \{ {π}_{i + 1} , {π}_{i + 2} , … , {π}_{K} \}}}\end{matrix} \qquad Eqn . ( 8 )$$

From Eq. (4) we can compute the received SNIR for user k using:

$$\begin{matrix}{SNIR}_{k} = \frac{{P}_{{S}_{k}} ( UT )}{{σ}_{{z}_{K}}^{2} + {P}_{{I}_{k} + {P}_{{MUI}_{k}}}} \\ = \frac{{\vert {v}_{k}^{T} {h}_{k} \vert}^{2} {P}_{k} ( AP )}{{σ}_{{z}_{K}}^{2} + {P}_{{I}_{k}} + {\sum }_{{{k}^{′} ∈ Ω ,}_{{k}^{′} ∈ \{ {π}_{i + 1} , {π}_{i + 2} , … , {π}_{K} \}}} {\vert {v}_{{k}^{′}}^{T} {h}_{k} \vert}^{2} {P}_{{k}^{′}}}\end{matrix} \qquad Eqn . ( 9 )$$

As can be seen the SNIR in downlink for each user is strongly related to the interference power as well as the channel matrix H. This scheme is indicated in FIG. 3, 324.

### (B) Inter-Cell Interference Mitigation:

In this arrangement a single node (which could be an enhanced AP or base station) termed Interference Controller Node (ICN) is dedicated to interference mitigation of a network or networks consisting of access points (AP) or user terminals (UT) located in its coverage area. These clients may consist of nodes in a single cell network, multi-cell networks or multiple adjacent networks in a geographic area. The interference mitigation process can be divided into two steps:
Interference Detection: This involves the process of ranging, sensing, detection and/or characterization of the interference power (as labeled in FIG. 3, 336) and can be categorized to direct and indirect interference detection.
Interference Correction: It includes all the actions necessary to reduce or cancel the interference effect.

Direct Interference Detection: In some embodiments the interference affecting the network nodes (NN) which could consist of UTs and/or APs, is directly detected at the ICN central node. In some embodiments both UT and AP are considered for ICN-assisted interference mitigation. In other embodiments, depending on the application, either UT's or AP's are considered for the ICN-aided interference mitigation. For example in a networks with a large number network cells and no frequency reuse it may be more effective to only combat the UT interference due to the potential overlap between the cell boundaries. In some embodiments the interferer parameters are detected by a simple spectral sensing including estimation of power and bandwidth of the signal. In other embodiments, in addition to the spectral sensing, other characteristics of the signal are collected including the signal statistics. Prior to interference mitigation and upon power up, the ICN tries to connect to its neighboring nodes (or register with them) to establish information about the relative location of each network node within its range. In some embodiments this information is collected by first registering as a UT node of the network currently being assessed and through ranging methods. For example in WLAN this can be established through well-studied signaling strategies proposed for WiFi ranging [see Refs. 24, 25]. Once the location of nodes of interest are established two flavors of direct interference detection may be used.

(a) Homogenous Direct Interference Detection: This method is best suited to scenarios where there is no strong line-of-site in majority of network's communications with the ICN. In this approach, referred to in FIG. 3 as block 342, the ICN scans the whole area within its coverage footprint. To establish the required link budget the ICN employs robust low data rate communications (constituting a robust modulation and coding strategy). In some embodiments, the ICN employs advanced smart antenna methodologies to communicate with the network nodes and/or sense the interference. These strategies not only help with expanding the coverage of ICN, but also ensure a robust data messaging exchange between the network nodes and the ICN. As a result, implementing the smart antenna methodologies can enhance the sensitivity of interference detection, while effectively providing the “spatial spectral sensing”. For example through the usage of space-time antenna processing [see Refs. 26,27] the ICN can provide accurate spatial interference sensing by pointing the antenna gain towards a specific direction while blocking the other signals that may be received from other direction and interfere with the directional interference sensing (this includes blocking radiations from ordinary communications in the network(s) received from different directions). In some embodiment an adaptive array can be used to establish an accurate sensing of the power and angular position of the interference signal. In some other embodiments simpler adaptive antenna techniques like beam switching (e.g. using a Butler Matrix [see Refs. 13,14] to generate a multibeam pattern) is used to detect the interference signal and its coarse angular location (as well as, the affected user terminal(s) and the access points). Note that the interference is not likely to be confused with the network node communications, as the location of these network nodes (and hence the direction of arrival of their radiation at the ICN) are known a priori at the ICN. In addition for out of network interferers (such as microwave oven and the codeless phones) the interference leaves a completely different signature at the ICN of interference (in terms of bandwidth, duty cycle, etc.).

FIG. 2 illustrates an example Homogenous Direct Interference Detection for a WLAN system based on beam switching at the ICN node 220. In this scenario a single cell constituted of an access point 200 and a user terminal 206 is illustrated. As can be seen the distance between the AP and UT is far enough to have a larger interference zone 212 (with a radius R_{I}(UT)) than the UT's transmission zone 214 (with radius R_{Tx}(UT)). The ICN node 220 switches its beam 222 to different directions over the coverage zone of interest 224. A hidden interferer 216 is located in the undetectable interference zone 212 with a transmission range that is affecting the UT 206 reception. As can be seen a coarse angular location for this interferer is detectable by the ICN, once the beam is switched towards its location.

(b) Selective Direct Interference Detection: This method is more efficient when there are strong LOS (line-of-sight) links to the ICN (shown in FIG. 3 as block 344). In some embodiment once the relative location of each access point is computed and stored, the ICN generates a map or image of potential interference zones within its coverage range. To establish this, signaling messages are exchanged between the ICN and the network(s) of interest to collect some important network parameters (e.g. SNR-threshold) required for performing the so-called interference zone analysis. In CSMA/CA based networks like WLAN, the interference zone analysis can be based on computing the undetectable interference zones by establishing the relation between transmission zone and interference zone of each node as discussed previously herein. Once these zones are defined the ICN can use smart antenna methods similar to those defined for homogenous direct interference detection. The only difference is that the footprint of potential undetectable interference regions is used by the ICN such that it only scans (monitors) these regions for potential interference detection. This can potentially speed up the interference detection, which is more critical as the size of network(s) grows.

Indirect Interference Detection: In this approach the interference is not directly detected at the ICN node. Instead, the existence of an interferer source and its power level can be established indirectly through close monitoring of the interference parameters such as SNIR of the network nodes (AP, UT or both nodes may be considered for the measurements). In some embodiments, prior to interference mitigation and upon power up, the ICN connects itself to the network to establish information about the relative location of each network node within its range. This information is collected by first registering as a UT node of the network currently being assessed and through ranging methods. For example in WLAN this can be established through signaling strategies proposed for ranging [see Refs. 24, 25]. Once the location of nodes is established the SNIR and/or other interference parameters for each node is measured to be associated with each node location. This scheme is shown in FIG. 3 block 340. In some embodiments the interference indicators such as SNIR measurement can be obtained through a fast feedback channel communicating the value measured at the receiver of the network node back to the ICN. In some embodiments, this SNIR (and/or other parameter(s)) can be averaged over a sliding sample window with a size determined by the expected coherence time of the channel Once the variations of the SNIR (and/or other parameter(s)) are consistently above certain threshold, the ICN concludes that an interferer is affecting the network node.

Combined Interference Detection: Referring to FIG. 3 some embodiments may use a combined interference detection approach 346. This strategy can help avoiding unnecessary false alarms and speedup the feedback channel information (e.g. SNIR measurement) similar to the approach 312 described previously herein. In some embodiments, similar to the intra-cell interference mitigation, the interference power measurement helps the AP controlled mechanisms for downlink interference mitigation and/or improvement of the spectral efficiency (such as precoding, MAC scheduling, etc.).

Interference Correction: In various embodiment once the interference affecting a network node is detected by the ICN (whether using direct or indirect interference detection), its harmful effect on the network node reception (AP, UT or both) is corrected or reduced using a methodology for updating the parameters of the interference mitigation strategy used in the network node and is communicated to that node through as series of messages (See FIG. 3, 348). When the target network node is an AP node, this can be performed through a direct transmission to the AP. When the target network node is a UT node, this communication can be performed through a direct transmission to the UT, or by using the AP to relay this messaging to the target UT. The latter option is usually considered when UT to UT communication is not possible (e.g. a star network topology, or when AP based correction of the UT interference is considered). In some other embodiments, the ICN performs a coordinated processing of the interference data (e.g. SNIR levels) received from the network nodes in order to achieve more reliable interference detection. In general the interference correction methodologies can be categorized into AP-based and UT-based interference correction methodologies.

AP-Based Correction: In AP-based correction, if the target node is the AP itself knowledge of interference parameters such as SNIR is directly used for adjustment of the AP interference mitigation parameters. For example in a WLAN network this knowledge can be used to adjust the back-off window size of the CSMA/CA strategy used for AP transmissions. In this case methodologies similar to the UT-based Intra-cell Interference Mitigation defined above may be used. On the other hand if the target node is a UT (FIG. 3, 354), this information may used for adjustment of the resource allocation strategy at the AP (FIG. 3, 358). When MUD is used, the order of channel assignments to different users is affected by the interference detection such that nodes with interference obtain lower priorities in the resource allocation process. In this case methodologies defined above for AP-based Intra-cell Interference Mitigation may be used. FIG. 3 shows that depending on the application ACSMA 360 and/or Modified DPC 362 may be used for interference mitigation of the UT (similar to blocks 322 and 324 in infra-cell mitigations respectively).

UT-Based Correction: The UT-based correction, is usually used when the target node is a UT (FIG. 3, 366). In this case knowledge of SINR is directly used for adjustment of the UT interference mitigation parameters. For example in a WLAN network this knowledge can be used to adjust the back-off window size of the CSMA/CA strategy is used in an adaptive CSMA (ACSMA) strategy for the UT transmissions. In this case methodologies defined above for UT-based Infra-cell Interference Mitigation may be used.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

### APPENDIX I

### References

Each of the following references are incorporated by reference herein in their entirety.
[1] L. Georgiadis, M. J. Neely and L. Tassiulas, “Resource Allocation and Cross Layer Control in Wireless Networks,” New Publishers Inc., 2006.
[2] IEEE Signal Processing, Special Issue on Advances in Signal Processing-Assisted Cross-Layer Designs, Vol. 86, Issue 8, August 2006.
[3] IEEE Journal of Selected Areas in Communications, Vol. 25, No. 4, May 2007.
[4] S. Mathialagan, S Shanmugavel “A Cross-Layer Design Approach using MIMO System for Wireless Networks,” 2008 IEEE Region 10 Colloquium and the Third ICIIS, Kharagpur, INDIA Dec. 8-10, 2008.
[5] D. Qiao et al, “Goodpoint analysis and link adaptation for IEEE 802.11a wireless LANs,” IEEE Trans. on Mobile Computing, Vol. 1, Issue 4, December 2002.
[6] B. Zerlin et al, “On cross-layer assisted resource allocation in HSDPA,” Proc. 12^{th} IEEE International Conference on Telecommunications, May 2005.
[7] Q. Liu et al, “Cross-layer modeling of adaptive wireless links for QoS support in heterogeneous wired-wireless networks,” ACM/Kluwer Journal of Wireless Networks (WINET), Vol. 12, pp. 427-437, May 2006.
[8] A. Todini, et al, “Cross-layer design of packet scheduling and resource allocation algorithms for 4G cellular systems,”
[9] R. Ferrus et. al, “Cross-Layer Scheduling Strategy for UMTS downlink Enhancement,” IEEE Radio Communications, pp. 25-28, June 2005.
[10] R. Knopp and P. A. Humblet, “Information capacity and power control in single-cell multiuser communications,” Proc. IEEE ICC, June 1995.
[11] M. Costa (May 1983). “Writing on dirty paper”. IEEE Trans. Information Theory 29: 439-441.
[12] S. Srikanteswara, et al, “Cross Layer Interference Mitigation Using Spectrum Sensing,” IEEE GLOBECOM 2007 Proceedings, pp. 3553-3557.
[13] Shao-Hua Chu, Hsin-Piao Lin, Ding-Bing Lin, “Performance Enhancement by Using Switch-Beam Smart Antenna in 802.11a WLAN System,”
[14] Nhi T. Pham, Gye-An Lee, and Franco De Flaviis, “Microstrip Antenna Array with Beamforming Network for WLAN Applications,”
[15] IEEE Standard, 802.11, “Wireless LAN Media Access Control (MAC) and Physical Layer (PHY) Specifications,” 1999.
[16] Tim C. W. Schenk, Guido Dolmans and Isabella Modonesi, “Throughput of a MIMO OFDM based WLAN system,” Proc. Symposium IEEE Benelux Chapter on Communications and Vehicular Technology, 2004 (SCVT2004), Gent, Belgium, November 2004.
[17] Alex Lackpour, “Maximizing Wireless LAN Range by Exploiting Two Types of Antenna Diversity,” white paper, Oberon Wireless, Inc., 2004, http://www.oberonwireless.com/WebDocs/Partner_Resources/Oberons Maximizing Wireless LAN Range by Exploiting Two Types of Antenna Diversity.
[18] Evgenia Adamopoulou, Konstantinos Demestichas, and Michael Theologou, “Enhanced Estimation of Configuration Capabilities in Cognitive Radio,” IEEE Communications Magazine, April 2008.
[19] Shibing ZHANG, Zhihua BAO, “Strategy of Anti-Interference Based on Cognitive Radio in Ultra-Wideband System,” 4^{th} International Conference on Wireless Communications, Networking and Mobile Computing, WiCOM '08, 2008
[20] Alan V. Oppenheim and Ronald W. Schafer, Digital Signal Processing, NJ, Prentice-Hall, 1981.
[21] Gawthrop, F. H. Sanders, K. B. Nebbia, J. J. Sell, “Radio spectrum measurements of individual microwave ovens,” NTIA Report 94-303-1.
[22] Realp, M.; Perez-Neira, A. I.; Mecklenbrauker, C. “A cross-layer approach to multi-user diversity in heterogeneous wireless systems,” IEEE International Conference on Communications, 2005. ICC 2005. Volume 4, May 2005, Pages: 2791-2796 Vol. 4.
[23] Bartolome, D.; Perez-Neira, A. I., “Spatial scheduling in multiuser wireless systems: from power allocation to admission control,” IEEE Transactions on Wireless Communications, Volume 5, Issue 8, Date: August 2006, Pages: 2082-2091.
[24] Z. Xiang, S. Song, J. Chen, H. Wang, J. Huang, X. Gao “A wireless LAN based indoor positioning technology,” IBM J. RES. & DEV. VOL. 48 NO. 5/6 SEPTEMBER/NOVEMBER 2004
[25] M. Ciurana, F. Barcelo-Arroyo and F. Izquierdo, “A ranging method with IEEE 802.11 data frames for indoor localization,” WCNC 2007 proceedings, 2007.
[26] Angeliki Alexiou, Martin Haardt, “Smart Antenna Technologies for Future Wireless Systems: Trends and Challenges,” IEEE Communications Magazine, September 2004,
[27] David Gesbert, Mansoor Shafi, Da-sham Shin, “From Theory to Practice: An Overview of MIMO Space-Time Coded Wireless Systems,” IEEE Journal on Selected Areas in Communications, Vol. 21, No. 3, APRIL 2003 281.

### APPENDIX II

### Exemplary Vector Calculations

The precoding at the AP constitutes multiplication of a K-dimensional vector vₖ. by the signal vector s. Vectors are in fact the rows of precoding matrix V (size M×K). Assuming a noise vector z and an interference vector I, the received signal vector is represented by

y=H′Vs+z+I

$$[ \begin{matrix}{y}_{1} \\ {y}_{2} \\ ⋮ \\ {y}_{k} \\ ⋮ \\ {y}_{K}\end{matrix} ] = [ \begin{matrix}{h}_{11}^{′} & {h}_{12}^{′} & … & {h}_{1 k}^{′} & … & {h}_{1 M}^{′} \\ {h}_{21}^{′} & {h}_{22}^{′} & … & {h}_{2 k}^{′} & … & {h}_{2 M}^{′} \\ ⋮ & ⋮ & ⋮ & ⋮ & ⋮ & ⋮ \\ {h}_{k 1}^{′} & {h}_{k 2}^{′} & … & {h}_{kk}^{′} & … & {h}_{kM}^{′} \\ ⋮ & ⋮ & ⋮ & ⋮ & ⋮ & ⋮ \\ {h}_{K 1}^{′} & {h}_{K 2}^{′} & … & {h}_{Kk}^{′} & … & {h}_{KM}^{′}\end{matrix} ] \times \\ [ \begin{matrix}{v}_{11} & {v}_{12} & … & {v}_{1 k} & … & {v}_{1 K} \\ {v}_{21} & {v}_{22} & … & {v}_{2 k} & … & {v}_{2 K} \\ ⋮ & ⋮ & ⋮ & ⋮ & ⋮ & ⋮ \\ {v}_{k 1} & {v}_{k 2} & … & {v}_{kk} & … & {v}_{kK} \\ ⋮ & ⋮ & ⋮ & ⋮ & ⋮ & ⋮ \\ {v}_{M 1} & {v}_{M 2} & … & {v}_{Mk} & … & {v}_{MK}\end{matrix} ] \times [ \begin{matrix}{s}_{1} \\ {s}_{2} \\ ⋮ \\ {s}_{k} \\ ⋮ \\ {s}_{K}\end{matrix} ] + [ \begin{matrix}{z}_{1} \\ {z}_{2} \\ ⋮ \\ {z}_{k} \\ ⋮ \\ {z}_{K}\end{matrix} ] + [ \begin{matrix}{I}_{1} \\ {I}_{2} \\ ⋮ \\ {I}_{k} \\ ⋮ \\ {I}_{K}\end{matrix} ] \\ [ \begin{matrix}{y}_{1} \\ {y}_{2} \\ ⋮ \\ {y}_{k} \\ ⋮ \\ {y}_{k}\end{matrix} ] = [ \begin{matrix}{h}_{1}^{′} {v}_{1}^{C} & {h}_{1}^{′} {v}_{2}^{C} & … & {h}_{1}^{′} {v}_{k}^{C} & … & {h}_{1}^{′} {v}_{K}^{C} \\ {h}_{2}^{′} {v}_{1}^{C} & {h}_{2}^{′} {v}_{2}^{C} & … & {h}_{2}^{′} {v}_{k}^{C} & … & {h}_{2}^{′} {v}_{K}^{C} \\ ⋮ & ⋮ & ⋮ & ⋮ & ⋮ & ⋮ \\ {h}_{k}^{′} {v}_{1}^{C} & {h}_{k}^{′} {v}_{2}^{C} & … & {h}_{k}^{′} {v}_{k}^{C} & … & {h}_{k}^{′} {v}_{K}^{C} \\ ⋮ & ⋮ & ⋮ & ⋮ & ⋮ & ⋮ \\ {h}_{K}^{′} {v}_{1}^{C} & {h}_{K}^{′} {v}_{2}^{C} & … & {h}_{K}^{′} {v}_{k}^{C} & … & {h}_{K}^{′} {v}_{K}^{C}\end{matrix} ] \times [ \begin{matrix}{s}_{1} \\ {s}_{2} \\ ⋮ \\ {s}_{k} \\ ⋮ \\ {s}_{k}\end{matrix} ] + [ \begin{matrix}{z}_{1} + {I}_{1} \\ {z}_{2} + {I}_{2} \\ ⋮ \\ {z}_{k} + {I}_{k} \\ ⋮ \\ {z}_{K} + {I}_{K}\end{matrix} ] ,$$

where, vₖ^{c}=

$$[ \begin{matrix}{v}_{1 k} \\ {v}_{2 k} \\ ⋮ \\ {v}_{kk} \\ ⋮ \\ {v}_{Mk}\end{matrix} ]$$

is the kth column of V,

and, h′ₖ=[h′ₖ₁ h′ₖ₂ . . . h′ₖₖ . . . h′_{kM}] is the kth row of H′ (A.1)

Eq. A.1 can be further modified to

y=H′Vs+z+I

$$[ \begin{matrix}{y}_{1} \\ {y}_{2} \\ ⋮ \\ {y}_{k} \\ ⋮ \\ {y}_{k}\end{matrix} ] = [ \begin{matrix}{h}_{1}^{′} {v}_{1}^{C} {s}_{1} + {\sum }_{{{k}^{′} ,}_{{k}^{′} \neq 1}} {h}_{1}^{′} {v}_{{k}^{′}}^{C} {s}_{{k}^{′}} \\ {h}_{2}^{′} {v}_{2}^{C} {s}_{2} + {\sum }_{{{k}^{′} ,}_{{k}^{′} \neq 2}} {h}_{2}^{′} {v}_{{k}^{′}}^{C} {s}_{{k}^{′}} \\ ⋮ \\ {h}_{k}^{′} {v}_{k}^{C} {s}_{k} + {\sum }_{{{k}^{′} ,}_{{k}^{′} \neq k}} {h}_{k}^{′} {v}_{{k}^{′}}^{C} {s}_{{k}^{′}} \\ ⋮ \\ {h}_{K}^{′} {v}_{K}^{C} {s}_{K} + {\sum }_{{{k}^{′} ,}_{{k}^{′} \neq K}} {h}_{K}^{′} {v}_{{k}^{′}}^{C} {s}_{{k}^{′}}\end{matrix} ] + [ \begin{matrix}{z}_{1} + {I}_{1} \\ {z}_{2} + {I}_{2} \\ ⋮ \\ {z}_{k} + {I}_{k} \\ ⋮ \\ {z}_{K} + {I}_{K}\end{matrix} ] \qquad ( A .2 )$$

Now if the channel is reciprocal (a good assumption in wireless networks) matrices H and H′ are transpose of one another, i.e. hᵢⱼ=h′ⱼᵢ. Assuming a normalized matrix such V that VV^{H}=I, and after some simplification we have:

$$[ \begin{matrix}{y}_{1} \\ {y}_{2} \\ ⋮ \\ {y}_{k} \\ ⋮ \\ {y}_{K}\end{matrix} ] = [ \begin{matrix}{v}_{1}^{R} {h}_{1} {s}_{1} + {\sum }_{{{k}^{′} ,}_{{k}^{′} \neq 1}} {v}_{{k}^{′}}^{R} {h}_{1} {s}_{{k}^{′}} \\ {v}_{2}^{R} {h}_{2} {s}_{2} + {\sum }_{{{k}^{′} ,}_{{k}^{′} \neq 2}} {v}_{{k}^{′}}^{R} {h}_{2} {s}_{{k}^{′}} \\ ⋮ \\ {v}_{k}^{R} {h}_{k} {s}_{k} + {\sum }_{{{k}^{′} ,}_{{k}^{′} \neq k}} {v}_{{k}^{′}}^{R} {h}_{k} {s}_{{k}^{′}} \\ ⋮ \\ {v}_{K}^{R} {h}_{K} {s}_{K} + {\sum }_{{{k}^{′} ,}_{{k}^{′} \neq K}} {v}_{{k}^{′}}^{R} {h}_{K} {s}_{k}\end{matrix} ] + [ \begin{matrix}{z}_{1} + {I}_{1} \\ {z}_{2} + {I}_{2} \\ ⋮ \\ {z}_{k} + {I}_{k} \\ ⋮ \\ {z}_{K} + {I}_{K}\end{matrix} ] \\ where , h = [ \begin{matrix}{h}_{1 k} \\ {h}_{2 k} \\ ⋮ \\ {h}_{kk} \\ ⋮ \\ {h}_{Mk}\end{matrix} ] is the \qquad ( A .3 )$$

kth column of H, and, vₖ^{R}=[vₖ₁ vₖ₂ . . . vₖₖ . . . v_{kK}] is the kth row of V

And finally by substituting vₖ^{T} for vₖ^{R} we can express the received signal at k-th UT (or UE) as:

$${y}_{k} - {v}_{k}^{T} {h}_{k} {s}_{k} + {\sum }_{{{k}^{′} ,}_{{k}^{′} \neq k}} {v}_{{k}^{′}}^{T} {h}_{k} {s}_{{k}^{′}} + {z}_{k} + {I}_{k} \qquad ( A .4 )$$

where, hₖ=[h₁ₖ h₂ₖ . . . hₖₖ . . . h_{Mk}]^{T}, vₖ^{T}=[vₖ₁ vₖ₂ . . . vₖₖ . . . v_{kK}]

What is claimed is:

1. A method of mitigating interference between a transmitter node and a receiver node in a wireless network, wherein said transmitter node executes a transmitter stack comprising a plurality of layers, each of said plurality of layers in communication with a corresponding peer layer of at least said receiver node, said method comprising:
executing a process, said process enabling at least a first layer of said plurality of layers to communicate with a second layer of at least said receiver node;
transmitting one or more data from said transmitter node to said receiver node;
detecting at least one interference;
obtaining a characterization of said interference; and
correcting for said at least one interference via one or more corrective actions communicated via said process.

2. The method of claim 1, wherein said process comprises a cross-layer process, and said second layer is not the corresponding peer layer of said first layer.

3. The method of claim 1, wherein said detection comprises expanding a carrier sensing range.

4. The method of claim 1, further comprising receiving feedback from said receiver node, said feedback comprising information enabling said detection of said at least one interference.

5. The method of claim 1, further comprising receiving feedback at said transmitter node, said feedback comprising said characterization of said at least one interference.

6. The method of claim 1, wherein said detecting is performed at multiple nodes of said wireless network.

7. The method of claim 6, wherein said multiple nodes includes said transmitter node and said receiver node.

8. The method of claim 7, wherein said transmitter node comprises a base station, and said receiver node comprises a user terminal.

9. The method of claim 7, wherein said transmitter node comprises a user terminal, and said receiver node comprises a base station.

10. The method of claim 6, wherein said multiple nodes includes at least one other node, said at least one other node not being said transmitter node or said receiver node.

11. The method of claim 1, where at least one of said one or more corrective actions comprises adaptive resource allocation at the transmitter node, said adaptive resource allocation being based at least in part on said characterization of said at least one interference.

12. The method of claim 1, where at least one of said one or more corrective actions comprises precoding at the transmitter node, said precoding being based at least in part on said characterization of said at least one interference.

13. The method of claim 1, wherein said act of correcting for said interference is performed by said receiver node, via one or more corrective actions communicated by said transmitter node to the said receiver node.

14. The method of claim 13, wherein at least a portion of said communication by said transmitter node to said receiver node is further communicated to at least the second layer of said receiver node via a cross-layer process.

15. The method of claim 1, wherein said act of detecting comprises determining a location of a source of said at least one interference source.

16. The method of claim 15, wherein said location determination of said source of said at least one interference is performed at least in part by other network nodes.

17. The method of claim 16, wherein said location determination comprises triangulation using at least said other network nodes.

18. The method of claim 15, wherein said the location determination of is performed using one or more substantially directional antenna beams.

19. The method in claim 15, further comprising estimating of one or more characteristics of said at least one interference based at least in part on said location determination.

20. Communications apparatus for communicating via a wireless network, said apparatus comprising:
a wireless interface, said wireless interface having one or more adjustable parameters;
a digital processor; and
a storage apparatus having a storage medium with at least one computer program stored thereon, the at least one computer program being configured to, when executed by the digital processor:
communicate via said wireless interface with one or more other peer devices, wherein said communication comprises a plurality of messages, each of said plurality of messages associated with a function of said one or more other peer devices;
sense or detect an interference via said wireless interface;
characterize said interference; and
modify said one or more parameters, wherein said modified one or more parameters correcting at least in part for said interference.

21. The communications apparatus of claim 20, wherein said wireless interface comprises a spatial reception gain based on one or more of said adjustable parameters.

22. The communications apparatus of claim 20, wherein said modification of said one or more adjustable parameters adjusts said spatial reception gain.

23. The communications apparatus of claim 20, wherein said communications apparatus senses interference using at least an expanded carrier sensing range.

24. The communications apparatus of claim 20, wherein said communications apparatus is configured to receive feedback from one or more other peer devices, said feedback comprising a detected interference.

25. The communications apparatus of claim 24, wherein said communications apparatus is configured to receive feedback from a device that is not one of said one or more other peer devices, said feedback comprising a detected interference.

26. The communications apparatus of claim 20, where said spatial gain is substantially angular.

27. The communications apparatus of claim 20, where said wireless interface comprises a beamforming antenna array.

28. The communications apparatus of claim 20, wherein said wireless interface comprises apparatus configured to trigger at least one of said communication, sensing, characterization, or modification by said wireless apparatus.

29. The communications apparatus of claim 28, wherein said apparatus configured to trigger comprises first logic, said first logic configured to trigger based at least in part upon the outcome of an initial interference analysis performed at the said communications apparatus.

30. A method for operating a first node in a wireless network, said first node providing data to a plurality of other nodes, said data being useful for interference mitigation in said wireless network, said method comprising:
obtaining data relating to an interference affecting at least a portion of said plurality of other nodes, said act of obtaining performed by said first node; and
communicating said data to at least one of said plurality of other nodes;
wherein at least one of said plurality of other nodes is configured to perform interference mitigation based at least in part on said data.

31. The method of claim 30, wherein at least another of said plurality of other nodes is operating in a second wireless network, different than said wireless network.

32. The method of claim 30, wherein interference mitigation is performed by communicating said data to said plurality of nodes such that interference is substantially avoided by the said other nodes.

33. The method of claim 30, wherein interference mitigation is performed by communicating said data to said plurality of nodes such that interference is substantially corrected for at said other nodes.

34. A method of inter-cell interference mitigation in a wireless network having a plurality of cells and at least one node associated with respective ones of said cells, the method comprising:
implementing, for at least one of said cells, at least one of (i) a direct interference detection mechanism; and/or (ii) an indirect interference detection mechanism; and
triggering, based at least in part on said act of implementing, at least one of (i) an interference avoidance mechanism for at least one of said plurality of cells; and/or (ii) an interference correction mechanism for at least one of said plurality of cells.

35. The method of claim 34, wherein said implementing, for at least one of said cells, at least one of (i) a direct interference detection mechanism; and/or (ii) an indirect direct interference detection mechanism, comprises implementing both said direct and indirect interference detection mechanisms.

36. The method of claim 34, wherein said direct interference detection mechanism comprises using a substantially directional and extended antenna beam to detect interference and determine a transmission power associated therewith, said transmission power being determined based at least in part on (i) the received power, and (ii) a distance from apparatus performing said determination of transmission power.

37. The method of claim 34, wherein said indirect interference detection mechanism comprises evaluating one or more parameters associated with a receiver for one or more indicia of interference.

38. The method of claim 37, wherein said one or more indicia are selected from the group consisting of: (i) a reduction of the receiver signal-to-noise ration (SNR), and (ii) an increase in the bit error rate (BER) at the receiver.

39. The method of claim 34, wherein said act of implementing for at least one of said cells, and said act of triggering for at least one of said plurality of cells, are performed for the same one of said plurality of cells.

40. The method of claim 34, wherein said act of implementing for at least one of said cells, and said act of triggering for at least one of said plurality of cells, are performed for different ones of said plurality of cells.

41. A method of operating a wireless network having a plurality of cells, so as to mitigate interference, the method comprising:
utilizing a transmission range associated with a transmitting node; and
utilizing an extended carrier sensing region, said extended carrier sensing region having a range greater than that of said transmission range;
wherein said extended carrier sensing region enables detection of interference at a receiver node.

42. The method of claim 41, wherein said extended carrier sensing region is accomplished at least in part through use of a smart antenna.

43. The method of claim 41, wherein said extended carrier sensing region is accomplished at least in part through use of at least one of (i) a high sensitivity receiver, and/or (ii) a substantially directional mechanism for interference sensing.
